(19) United States
(12) Patent Application Publication
(10) Pub. No.: US 2025/0109884 A1
(43) Pub. Date: Apr. 3, 2025

(54) PROCESSES AND APPARATUSES FOR HEATING A PROCESS FLUID IN A HEATER

(71) Applicant: Honeywell International Inc., Charlotte, NC (US)

(72) Inventors: Kurt Edward Kraus, Tulsa, OK (US); Zhili Qin, Tulsa, OK (US); Timoleon Ballai, Chicago, IL (US); Emad Abbasi, Highland Park, IL (US)

(21) Appl. No.: 18/761,598

(22) Filed: Jul. 2, 2024

Related U.S. Application Data
(60) Provisional application No. 63/587,380, filed on Oct. 2, 2023.

(51) Int. Cl. F24H 1/00; C01B 3/36; F23C 1/00; F23L 7/00; F23N 1/08

(52) U.S. Cl. CPC F24H 1/0027; C01B 3/36; F23C 1/00; F23L 7/00; F23N 1/082; C01B 2203/0211; C01B 2203/1241; C01B 2203/84; F23C 2900/9901

(57) ABSTRACT

Processes and apparatuses for heating a process fluid with a heater having a burner. Fuel is passed to the burner and combusts to product heat. An inert gas stream is provided to the burner, either upstream or downstream or both, of the burner. The flow of the inert gas stream is controlled based on a composition of the fuel, with more inert gas being passed downstream of the burner to when the amount of hydrogen in the fuel is increased.

### CROSS-REFERENCES TO RELATED APPLICATIONS

This application claims the benefit of U.S. Provisional Patent Application Ser. No. 63/587,380 filed on Oct. 2, 2023, the entire disclosure of which is incorporated herein by way of reference.

### FIELD OF THE INVENTION

This invention relates generally to processes and apparatuses for heating a process fluid in a heater, and more specifically to such heaters that include a burner receiving a hydrogen fuel.

### BACKGROUND OF THE INVENTION

For a given furnace design, (radiant coil, burners, convention section designs) and feedstock composition, there is an optimal crossover temperature to result in optimal, maximum runtime, yield, conversion and efficiency. For example, for steam cracker furnace designers, process licensors, and end users use computational yield models (cracking models, sch as SPIRO® from Technip Energies) to predict the optimal crossover temperature, among many other process variables, which can be optimized to maximize yield, maximize conversion of paraffins to desired olefins such as ethylene.

Maintaining optimal feed crossover temperature, the temperature of the mixed steam and steam cracker feed from a convection section to a radiant section, is critical to achieving profitable steam cracker production. In simplistic terms, too low of a feed crossover temperature results in low rates of conversion of paraffins to olefins, too little cracking, low yield. Too high and the feed crossover temperature results in rapid coke build up in the coil resulting in short runtime between decoking cycles. Decoking the cracker results in downtime, lost production and lost profit.

As process conditions change, the cracking model can be rerun to predict optimal variables. Changing process conditions can include changes in feedstock, such as changing naphtha composition, or feed gas ethane content, changes in fuel gas, excess combustion air, atmospheric conditions, etc.

For example, a change in fuel gas composition from 100% by volume methane to 100% by volume hydrogen will result in a reduction of the mass flow rate through the furnace of approximately 19%. While this extreme change in mass flow rate could potentially happen, it is unlikely in a steam cracker as steam crackers do not usually fire pure methane or natural gas. The methane content in the fuel gas of a steam cracker running on process off gas is often 30% to 90% by volume hydrogen. But when going to 100% hydrogen firing for zero carbon emissions from any amount of hydrocarbon fuel firing, the mass flow rate is reduced. Moreover, in other processes, the large reduction in mass flow rate is possible. If no other process variables change, the firing rate is constant, these reductions in mass flow rate can result in a significant reduction of crossover temperature of a few hundred degrees resulting in potentially halving of conversion of paraffins to olefins, halving productivity and potentially making operations unprofitable.

Accordingly, it would be desirable to provide systems and processes that accommodate hydrogen fuels.

### SUMMARY OF THE INVENTION

The present invention utilizes inert gases to provide mass flow and ensure desired burner and heater operation. The present invention provides the benefit of being able to transition to high hydrogen, low carbon emitting fuel gasses without suffering loss of efficiency due to loss of mass flow through the convection section. Further, the present invention adds additional degrees of freedom to separately optimize system mass flow rate while optimizing nitric oxide emission.

This invention solves the problem of reduced mass flow rate through the convection section when a steam cracking furnace is operated on high-hydrogen content fuel to reduce carbon emissions rather than firing the conventional hydrocarbon content fuel gases. The reduced mass flow rate through the furnace results from firing hydrogen and, for a given firing rate in radiant section (combustion chamber) and significantly reduces conductive heat transfer in the convection section of the furnace. The convection section is sized to heat various stream including water to make steam for the steam cracking process, steam for export, paraffin preheating before injection into the radiant section (the radiant section furnace tubes serving as the paraffin to olefin conversion reactors, where olefins are made). Whether a new unit or retrofit, the convection section must be design for the higher mass flow rate of hydrocarbon fuel firing to allow flexible operation of the unit to and from low carbon, hydrogen firing operation. This invention injects freely available nitrogen from the ATR or other inert gas sources into the furnace system to restore and modulate the mass flow rate to optimize the convection section efficiency. Convection section efficiency can be measure by monitoring or predicting the process crossover temperature as the process fluid move from convection to radiant section. This invention provides operators, furnace designers, and process licensors a new degree of freedom—the modulation of the system mass flow rate to optimize convention section efficiency without adversely changing other variables such as excess air and firing rate.

Therefore, the present invention may be characterized, in at least one aspect, as providing a process for heating a process fluid stream in a heater by: determining a composition of a fuel passed to a burner of a heater, wherein the fuel is combusted to produce heat, and wherein the composition of the fuel is a hydrogen fuel, a hydrocarbon fuel, or a mixture of hydrogen and hydrocarbon; determining a mass flow rate for the heater based on the composition of the fuel; and, adjusting a flow of an inert gas stream to the heater based on the mass flow rate.

When the fuel composition is determined to comprise hydrogen or a mixture of hydrogen and hydrocarbon, the adjusting may include increasing the flow of the inert gas stream.

Adjusting the flow of the inert gas stream may also include comparing the mass flow rate to a target mass flow rate.

The inert gas stream may be passed to the burner. The inert gas stream may be mixed with the fuel prior to combustion.

The inert gas stream may be passed into a combustion zone of the heater. The combustion zone is downstream of the burner. The inert gas stream may also be passed to the burner, upstream of the combustion zone.

The process may also include separating an oxygen stream from air to provide an oxygen depleted stream, generating hydrogen with the oxygen stream in a thermal reformer. The hydrogen may be is the fuel, and the oxygen depleted stream may be the inert gas stream.

In another aspect the present invention may broadly be characterized as providing a process for heating a process fluid stream in a heater by: passing a fuel stream to a burner of a heater, wherein the heater comprises a radiant section with at least one conduit with a process fluid stream; combusting fuel from the fuel stream in a combustion zone to produce a flame and heat; passing an inert gas into the combustion zone, downstream of the flame to provide a heated, mass enriched flue gas; and, transferring heat from the heated, mass enriched flue gas to the process fluid stream in the radiant section.

The heater may have a convention section disposed above the radiant section, and the radiant section may include at least one conduit with a process fluid. The process may further include transferring heat from the heated, mass enriched flue gas to the process fluid stream in the convention section.

The process may also include passing a portion of the inert gas into the burner. The portion of the inert gas passed to the burner may be injected into a primary combustion zone. Additionally and/or alternatively, the portion of the inert gas passed to the burner may be mixed with the fuel stream. Additionally and/or alternatively, the portion of the inert gas passed to the burner may be injected into a secondary combustion zone.

The process may further include passing an air stream to a separation zone configured to provide an oxygen stream and an oxygen depleted stream, passing the oxygen stream to a thermal reformer configured, under appropriate conditions, to provide a hydrogen stream, passing the hydrogen stream to the burner as the fuel stream, and, passing the oxygen depleted stream to the combustion zone as the inert gas.

The process may also include determining an amount of hydrogen in the fuel stream, and adjusting a flow of the inert gas based on the amount of hydrogen. The process may include determining a mass flow rate from the amount of hydrogen, and, comparing the mass flow rate to a target mass flow rate. The adjusting of the flow of the inert gas may be based on a difference between the mass flow rate and the target mass flow rate.

In another aspect, the present invention provides a device for heating process fluid stream. The device may include a heater with a burner in a radiant section, the radiant section having at least one conduit with a process fluid stream, a burner configured to receive a fuel stream and combust the fuel stream in a combustion zone to produce a flame and heat, and a line configured to pass an inert gas into the combustion zone, downstream of the flame to provide a heated, mass enriched flue gas.

The device may also include a second line configured to provide a portion of the inert gas to the combustion zone.

The device may further include a controller configured to determine a composition of the fuel stream and a valve configured to adjust a flow of the inert gas in the line.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

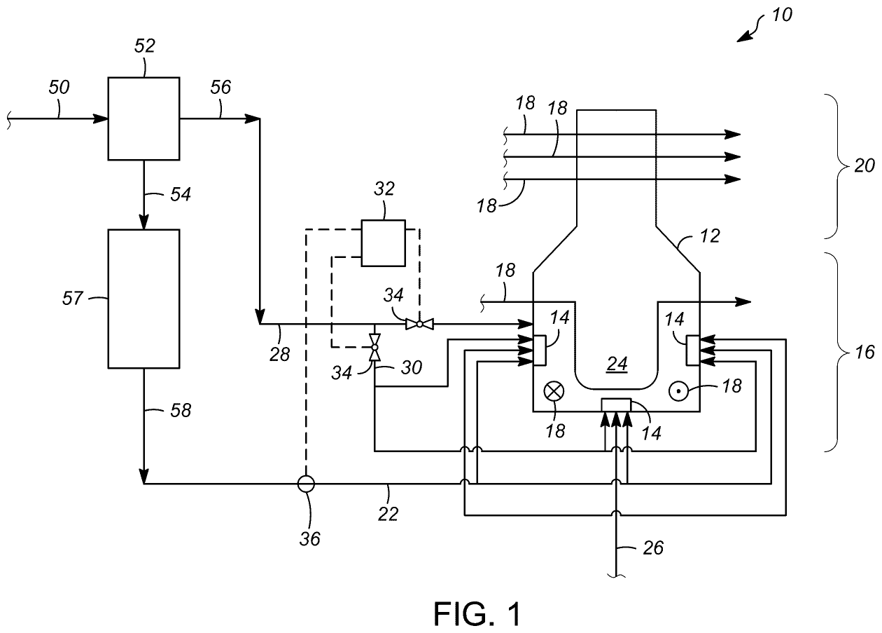

FIG. 1 shows a schematic view of an apparatus according to one or more embodiments implementing a process according to one or more embodiments.

### DETAILED DESCRIPTION OF THE INVENTION

As mentioned above, processes and apparatuses for heating a process stream have been invented. This invention maintains optimal crossover temperature by maintaining the optimal mass flow of the furnace system by injecting an inert gas, such as nitrogen or other readily available suitable gas, into the burners and furnace firebox as fuel hydrogen content varies.

While a mixed feed steam cracker is contemplated as a preferred embodiment, the present invention is applicable to any type of steam cracker including ethane feed or propane feed (gas crackers), naphtha feed (liquid crackers) or naphtha to Ethane & Propane (NEP) units (both the steam cracker furnaces and Oleflex® heaters). And while this invention contemplates application in steam cracking processes, the invention can be applied to any other processes utilizing fired heaters and furnaces.

In some steam cracking processing units, Auto Thermal Reforming, ATR is being considered or actively implemented. With an ATR, there is an air separator which separates oxygen from atmospheric air and delivers this to the ATR for use in hydrogen production. Meanwhile, the ATR produces significant volumes of nitrogen as a byproduct (from the air separator). While some attempts to productively utilize the byproduct nitrogen from the air separation unit, most is simply vented to atmosphere on a large-scale ATR use to produce sufficient hydrogen to fire a steam cracker train. The present invention allows for this gas stream to be utilized.

While this invention contemplates utilizing the significant volume of nitrogen from the air separator on an ATR, other sources of nitrogen in a process plant may be available from other air separators or other process sources. Further, a process plant may have available other gas streams which can be suitably utilized in this invention instead of, or in combination with, nitrogen, such as steam, flue gas, FCC unit off gases, or even carbon dioxide.

It is contemplated that the furnace design and yield models can be executed and design optimized in the project design phase. However, by constantly running the yield models as a real time digital twin to the operating furnaces, the rate of nitrogen injection can be constantly calculated and modulated to maintain the optimal mass flow through the burner and furnace systems the optimal mass in response to changing fuel gas composition, feed stock compositions, atmospheric conditions, etc.

The continuous optimization of nitrogen injection provides a degree of freedom for optimization that presently does not exist in existing furnace system. In existing systems, the operations can adjust mass flow rate principally by changing excess air and running at sub-optimal excess air levels, thereby wasting fuel gas. This invention may result in productivity, yield and uptime, that exceeds current system designs. Thereby going to net zero ethylene production utilizing this invention, 100% hydrogen firing, may be more efficient producer of olefins than conventional, existing technologies.

On-demand, targeted injection of nitrogen (or other inert gas) into one or more locations in the burner can reduce NOx emissions to a single digit ppm level, thereby eliminating the need or greatly reducing the size of a selective catalytic reduction system.

With these general principles in mind, one or more embodiments of the present invention will be described with the understanding that the following description is not intended to be limiting.

With reference to FIG. 1, a device 10 for heating one or more process fluid streams includes a heater 12, such as a furnace, which includes one or more burners 14. While any particular burners may be used, exemplary low NOx burners are described in U.S. Pat. No. 11,649,960.

The heater 12 has a radiant section 16 containing one or more conduits 18 which contain a process fluid. Multiple conduits 18 can be utilized, and each may contain a different process fluid to be heated. Above the radiant section 16 is typically a convection section 20 that also includes one or more conduits 18 which contain a process fluid. As is known, in the radiant section 16, heat is transferred from the flame to the process fluid, in the convection section 20, heat is transferred from hot flue gases to the process fluid.

Each burner 14 receives a fuel stream 22 which is passed into a combustion zone 24 within the heater 12 and which produces a flame and heat. The burners 14 each typically also receive a stream of combustion air 26 which may be mixed with the fuel stream 22 (or portions thereof).

As discussed at the outset, the fuel to the burner 14 may be hydrogen, hydrocarbon, or a mixture thereof having varying ratios of hydrogen to hydrocarbons. While there is a growing trend to utilize more and more hydrogen to reduce environmental impacts, the mass flow rate of flue gas from the radiant section 16 to the convection section 20 is reduced based on the amount of hydrogen in the fuel.

Accordingly, the present invention includes a line 28 configured to pass an inert gas into the combustion zone 24, downstream of the flame to provide a heated, mass enriched flue gas. By inert gas, it is meant that the gas includes compounds and that do not combust or otherwise chemically change in the combustion zone 24. Example inert gases include nitrogen, steam from, for example, a boiler or steam generator, flue gas from, for example, a heater or boiler exhaust, PSA off gas, FCC vent gas, FCC off gases, carbon dioxide, and combinations thereof.

Additionally, it is further contemplated that the device includes a second line 30 which provides a stream of inert gas to the combustion zone 24 by being sent to the burner 14. This can be used to reduce NOx emissions from the flame by lowering the available oxygen content in the combustion zone 24. The inert gas from line 30 may be provided to a primary combustion zone or to a secondary combustion zone, or both, depending on the burner design.

While the ability to increase the mass flow rate is improved, it is further desirable to provide for the ability to adjust to different fuel compositions ranging from pure hydrogen to pure hydrocarbon, and various mixtures therebetween.

Thus, a controller 32 may be communication one or more valves 34 located in lines 28, 30 carrying the inert gas. The controller 32 may receive signals or other information relating to a composition of the fuel. For example, sensors 36 may be provided in the line(s) carrying the fuel stream 22. Additionally, or alternatively, the composition may be entered or based on other information received from, for example, another controller/computer associated with a processing unit providing the fuel stream 22.

The controller 32 may then determine the composition of the fuel and determine a mass flow rate based on the determined composition. The controller 32 may then send or transmit signals which cause the valves 34 to adjust a flow rate of the inert gas in line 28 and/or line 30. For example, when the fuel is determined to by almost entirely hydrocarbon, the controller 32 may adjust the valves 34 so that nearly all, if not all, of the inert gas is passed to the burners 14. When the fuel is determined to have higher amounts of hydrogen, the flow rate of the inert gas to the radiant section 16 (in line 28 and/or line 30) may be increased. Thus, it should be understood that all of the inert gas may be passed to the burners 14, or all of the inert gas may be passed into the radiant section 16, or the insert gas may be split in any ratio between the two.

The mass flow determination may be performed continuously or intermittently. Additionally, the controller 32 may include memory storing a lookup table of target mass flow rates based on various variables for the heater 12 and the processing unit receiving the process fluid in conduits 18. Alternatively, the controller 32 may determine the target mass flow rate based on information received. The commands sent by the controller 32 may be to adjust conditions, in particular, but not exclusively, of the inert gas in lines 28 and/or line 30.

Thus, it should be appreciated and understood by those of ordinary skill in the art that various other components in communication with the controller 32, such as valves, pumps, filters, coolers, etc. were not shown in the drawings, as it is believed that the specifics of same are well within the knowledge of those of ordinary skill in the art and a description of same is not necessary for practicing or understating the embodiments of the present invention.

In FIG. 1, a specific embodiment is further shown and will be described with the understanding that the depicted embodiment is not intended to be limiting.

As depicted a stream of air 50 is passed to a separation zone 52 which is configured to separate the components thereof and provide an oxygen stream 54 and an oxygen depleted stream 56. The oxygen stream 54 may be passed to a thermal reformer zone 57 configured to, under appropriate conditions, provide a hydrogen stream 58 from an effluent of the reaction of oxygen with methane and water or carbon dioxide. The hydrogen stream 58 may be passed to the burners 14 as the fuel stream 22. To increase the mass flow based on the hydrogen fuel, the oxygen depleted stream 56 may be utilized as the inert gas 28 and passed to the radiant section 16/combustion zone 24 and/or burners 14.

The systems and devices described herein may include a controller 32 or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

### SPECIFIC EMBODIMENTS

While the following is described in conjunction with specific embodiments, it will be understood that this description is intended to illustrate and not limit the scope of the preceding description and the appended claims.

A first embodiment of the invention is a process for heating a process fluid stream in a heater, the process comprising determining a composition of a fuel passed to a burner of a heater, wherein the fuel is combusted to produce heat, and wherein the composition of the fuel is a hydrogen fuel, a hydrocarbon fuel, or a mixture of hydrogen and hydrocarbon; determining a mass flow rate for the heater based on the composition of the fuel; and, adjusting a flow of an inert gas stream to the heater based on the mass flow rate. An embodiment of the invention is one, any or all of prior embodiments in this paragraph up through the first embodiment in this paragraph, wherein when the fuel composition is determined to comprise hydrogen or a mixture of hydrogen and hydrocarbon, the adjusting comprises increasing the flow of the inert gas stream. An embodiment of the invention is one, any or all of prior embodiments in this paragraph up through the first embodiment in this paragraph, wherein adjusting the flow of the inert gas stream comprises comparing the mass flow rate to a target mass flow rate. An embodiment of the invention is one, any or all of prior embodiments in this paragraph up through the first embodiment in this paragraph, wherein the inert gas stream is passed to the burner. An embodiment of the invention is one, any or all of prior embodiments in this paragraph up through the first embodiment in this paragraph, wherein the inert gas stream is mixed with the fuel prior to combustion. An embodiment of the invention is one, any or all of prior embodiments in this paragraph up through the first embodiment in this paragraph, wherein the inert gas stream is passed into a combustion zone of the heater, the combustion zone downstream of the burner. An embodiment of the invention is one, any or all of prior embodiments in this paragraph up through the first embodiment in this paragraph, wherein the inert gas stream is also passed to the burner, upstream of the combustion zone. An embodiment of the invention is one, any or all of prior embodiments in this paragraph up through the first embodiment in this paragraph further comprising separating an oxygen stream from air to provide an oxygen depleted stream, generating hydrogen with the oxygen stream in a thermal reformer, wherein the hydrogen is the fuel, and wherein the oxygen depleted stream is the inert gas stream.

A second embodiment of the invention is a process for heating a process fluid stream in a heater, the process comprising passing a fuel stream to a burner of a heater, wherein the heater comprises a radiant section with at least one conduit with a process fluid stream; combusting fuel from the fuel stream in a combustion zone to produce a flame and heat; passing an inert gas into the combustion zone, downstream of the flame to provide a heated, mass enriched flue gas; and, transferring heat from the heated, mass enriched flue gas to the process fluid stream in the radiant section. An embodiment of the invention is one, any or all of prior embodiments in this paragraph up through the second embodiment in this paragraph, wherein the heater comprises a convention section disposed above the radiant section, wherein the radiant section comprises at least one conduit with a process fluid, and wherein the process further comprises transferring heat from the heated, mass enriched flue gas to the process fluid stream in the convention section. An embodiment of the invention is one, any or all of prior embodiments in this paragraph up through the second embodiment in this paragraph, further comprising passing a portion of the inert gas into the burner. An embodiment of the invention is one, any or all of prior embodiments in this paragraph up through the second embodiment in this paragraph, wherein the portion of the inert gas passed to the burner is injected into a primary combustion zone. An embodiment of the invention is one, any or all of prior embodiments in this paragraph up through the second embodiment in this paragraph, wherein the portion of the inert gas passed to the burner is mixed with the fuel stream. An embodiment of the invention is one, any or all of prior embodiments in this paragraph up through the second embodiment in this paragraph, wherein the portion of the inert gas passed to the burner is injected into a secondary combustion zone. An embodiment of the invention is one, any or all of prior embodiments in this paragraph up through the second embodiment in this paragraph, further comprising passing an air stream to a separation zone configured to provide an oxygen stream and an oxygen depleted stream; passing the oxygen stream to a thermal reformer configured, under appropriate conditions, to provide a hydrogen stream; passing the hydrogen stream to the burner as the fuel stream; and, passing the oxygen depleted stream to the combustion zone as the inert gas. An embodiment of the invention is one, any or all of prior embodiments in this paragraph up through the second embodiment in this paragraph, further comprising determining an amount of hydrogen in the fuel stream; and adjusting a flow of the inert gas based on the amount of hydrogen. An embodiment of the invention is one, any or all of prior embodiments in this paragraph up through the second embodiment in this paragraph, further comprising determining a mass flow rate from the amount of hydrogen; and, comparing the mass flow rate to a target mass flow rate, wherein the adjusting of the flow of the inert gas is based on a difference between the mass flow rate and the target mass flow rate.

A third embodiment of the invention is a device for heating process fluid stream comprising a heater with a burner in a radiant section, the radiant section comprising at least one conduit with a process fluid stream; a burner configured to receive a fuel stream and combust the fuel stream in a combustion zone to produce a flame and heat; a line configured to pass an inert gas into the combustion zone, downstream of the flame to provide a heated, mass enriched flue gas. An embodiment of the invention is one, any or all of prior embodiments in this paragraph up through the third embodiment in this paragraph further comprising a second line configured to provide a portion of the inert gas to the combustion zone. An embodiment of the invention is one, any or all of prior embodiments in this paragraph up through the third embodiment in this paragraph further comprising a controller configured to determine a composition of the fuel stream; and a valve configured to adjust a flow of the inert gas in the line.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for heating a process fluid stream in a heater, the process comprising:
determining a composition of a fuel passed to a burner of a heater, wherein the fuel is combusted to produce heat, and wherein the composition of the fuel is a hydrogen fuel, a hydrocarbon fuel, or a mixture of hydrogen and hydrocarbon;
determining a mass flow rate for the heater based on the composition of the fuel; and,
adjusting a flow of an inert gas stream to the heater based on the mass flow rate.

2. The process of claim 1, wherein when the fuel composition is determined to comprise hydrogen or a mixture of hydrogen and hydrocarbon, the adjusting comprises increasing the flow of the inert gas stream.

3. The process of claim 1, wherein adjusting the flow of the inert gas stream comprises:
comparing the mass flow rate to a target mass flow rate.

4. The process of claim 1, wherein the inert gas stream is passed to the burner.

5. The process of claim 4, wherein the inert gas stream is mixed with the fuel prior to combustion.

6. The process of claim 1, wherein the inert gas stream is passed into a combustion zone of the heater, the combustion zone downstream of the burner.

7. The process of claim 6, wherein the inert gas stream is also passed to the burner, upstream of the combustion zone.

8. The process of claim 1 further comprising:
separating an oxygen stream from air to provide an oxygen depleted stream,
generating hydrogen with the oxygen stream in a thermal reformer,
wherein the hydrogen is the fuel, and
wherein the oxygen depleted stream is the inert gas stream.

9. A process for heating a process fluid stream in a heater, the process comprising:
passing a fuel stream to a burner of a heater, wherein the heater comprises a radiant section with at least one conduit with a process fluid stream;
combusting fuel from the fuel stream in a combustion zone to produce a flame and heat;
passing an inert gas into the combustion zone, downstream of the flame to provide a heated, mass enriched flue gas; and,
transferring heat from the heated, mass enriched flue gas to the process fluid stream in the radiant section.

10. The process of claim 9, wherein the heater comprises a convention section disposed above the radiant section, wherein the radiant section comprises at least one conduit with a process fluid, and wherein the process further comprises:
transferring heat from the heated, mass enriched flue gas to the process fluid stream in the convention section.

11. The process of claim 9, further comprising:
passing a portion of the inert gas into the burner.

12. The process of claim 11, wherein the portion of the inert gas passed to the burner is injected into a primary combustion zone.

13. The process of claim 12, wherein the portion of the inert gas passed to the burner is mixed with the fuel stream.

14. The process of claim 11, wherein the portion of the inert gas passed to the burner is injected into a secondary combustion zone.

15. The process of claim 9, further comprising:
passing an air stream to a separation zone configured to provide an oxygen stream and an oxygen depleted stream;
passing the oxygen stream to a thermal reformer configured, under appropriate conditions, to provide a hydrogen stream;
passing the hydrogen stream to the burner as the fuel stream; and,
passing the oxygen depleted stream to the combustion zone as the inert gas.

16. The process of claim 9, further comprising:
determining an amount of hydrogen in the fuel stream; and
adjusting a flow of the inert gas based on the amount of hydrogen.

17. The process of claim 16, further comprising:
determining a mass flow rate from the amount of hydrogen; and,
comparing the mass flow rate to a target mass flow rate,
wherein the adjusting of the flow of the inert gas is based on a difference between the mass flow rate and the target mass flow rate.

18. A device for heating process fluid stream comprising:
a heater with a burner in a radiant section, the radiant section comprising at least one conduit with a process fluid stream;
a burner configured to receive a fuel stream and combust the fuel stream in a combustion zone to produce a flame and heat;
a line configured to pass an inert gas into the combustion zone, downstream of the flame to provide a heated, mass enriched flue gas.

19. The device of claim 18 further comprising:
a second line configured to provide a portion of the inert gas to the combustion zone.

20. The device of claim 18 further comprising:
a controller configured to determine a composition of the fuel stream; and
a valve configured to adjust a flow of the inert gas in the line.
